(19) United States
(12) Patent Application Publication
(10) Pub. No.: US 2015/0104241 A1
(43) Pub. Date: Apr. 16, 2015

(54) CONNECTOR FOR CABLES IN SERIES

(71) Applicant: Spartan Tool LLC, Mendota, IL (US)

(72) Inventors: John Nicholas Spelich, Peru, IL (US); Ross Allan Wilson, Utica, IL (US)

(73) Assignee: Spartan Tool LLC, Mendota, IL (US)

(21) Appl. No.: 14/509,716

(22) Filed: Oct. 8, 2014

Related U.S. Application Data
(60) Provisional application No. 61/891,132, filed on Oct. 15, 2013.

(51) Int. Cl. F16G 11/10; F16L 31/00; F16L 27/08

(52) U.S. Cl. CPC F16G 11/10; F16L 27/0804; F16L 31/00
USPC 403/62

(57) ABSTRACT

A coupler for rigidly connecting two cables in series in series is provided. The coupler includes a first component that includes a receiving volume that extends from a first end face of the first coupler. The receiving volume extends through a side surface of a body of the first component through an aperture. A second component is slidably engagable with the first coupler. The second component includes a finger that extends within the receiving volume, the finger includes a second portion that extends through the aperture. The second component can engage the first component with in a direction parallel to the longitudinal axis of the first component as well as in a direction perpendicular to the longitudinal axis of the first component.

### CROSS-REFERENCE TO RELATED APPLICATIONS

This application claims priority from U.S. Provisional Application No. 61/891,132, filed on Oct. 15, 2013, the entirety of which is hereby fully incorporated by reference herein.

### TECHNICAL FIELD

This disclosure relates to couplers for connecting together two elongate cables such that both cables are free to rotate together.

### BRIEF SUMMARY

A first representative embodiment of the disclosure is provided. The embodiment includes a coupler for rotatably attaching two sections of an elongate cable. The coupler includes a first component with a body that extends between a first end and a second end that is connectable to a first section, the body extending along a first longitudinal axis. The first component further comprises an opening disposed through a first face that defines the first end of the first component, the first face being planar and disposed substantially perpendicularly to the first longitudinal axis. The first component further comprises a receiving volume that extends from the opening and blindly toward the second end of the first component, the receiving volume being partially bounded by opposite first and second parallel side walls, and a first aperture that extends from the receiving volume through an arcuate side wall of the first component. A second component includes a body that extends between a first end and a second end that is connectable to an end of a second section, the body of the second component extends along a second longitudinal axis. The second component further comprises a flange and a finger that extends along the second longitudinal axis and includes a first portion that extends along the second longitudinal axis away from the flange, and a second portion that extends in a direction substantially perpendicular to the second longitudinal axis, wherein the first and second portions of the finger are both partially defined by opposite parallel side walls that are spaced apart substantially the same distance as a spacing between the first and second parallel side walls that partially bound the receiving volume. The finger is configured to be received within the receiving volume when the first and second components are connected together, with a top surface of the finger extending to the first aperture of the first component.

Another representative embodiment of the disclosure is provided. The embodiment includes a method of rotatably connecting two sections of a cable. The method includes the steps of providing a first component that includes a body that extends between a first end and a second end that is connectable to a first section, the body extending along a first longitudinal axis, the first component further comprising an opening disposed through a face that defines the first end of the first component, the first face being planar and disposed perpendicularly to the first longitudinal axis. The first component further comprises a receiving volume that extends from the opening and blindly toward the second end of the first component, the receiving volume being partially bounded by opposite first and second parallel side walls, and a first aperture that extends through an arcuate side wall of the first component and extends into the receiving volume. The method further includes the step of providing a second component including a body that extends between a first end and a second end that is connectable to an end of a second section, the body of the second component extending along a second longitudinal axis, the second component further comprising a flange and a finger that extends along the second longitudinal axis and includes a first portion that extends along the second longitudinal axis away from the flange, and a second portion that extends in a direction substantially perpendicular to the second longitudinal axis, wherein the first and second portions of the finger are both partially defined by opposite parallel side walls that are spaced apart substantially the same distance as a spacing between the first and second parallel side walls that partially bound the receiving volume. The method additionally includes the step of advancing the finger into the receiving volume and displacing the second component perpendicularly to the first longitudinal axis until a top surface of the finger extends to the first aperture of the first component.

Advantages of the disclosed device will become more apparent to those skilled in the art from the following description of embodiments that have been shown and described by way of illustration. As will be realized, other and different embodiments are contemplated, and the disclosed details are capable of modification in various respects. Accordingly, the drawings and description are to be regarded as illustrative in nature and not as restrictive.

### BRIEF DESCRIPTION OF THE DRAWINGS

FIG. 1 is a perspective view first and second cables rigidly connected together with a coupler.

FIG. 2 is a top perspective view of the coupler of FIG. 1 with the first and second components forming the coupler engaged together.

FIG. 3 is a bottom perspective view of the coupler of FIG. 1.

FIG. 4 is an exploded view of the first and second components of the coupler.

FIG. 5 is a perspective view of a first component of the coupler of FIG. 1.

FIG. 6 is a side view of the first component of FIG. 5.

FIG. 7 is a top view of the first component of FIG. 5.

FIG. 8 is a perspective view of the second component of the coupler of FIG. 1.

FIG. 9 is a side view of the second component of FIG. 8.

FIG. 10 is a bottom view of the second component of FIG. 8.

FIG. 11 is a perspective view of the second component approaching the first component in a direction parallel to the longitudinal axis of the first component.

FIG. 12 is a perspective view of the second component approaching the first component in a direction that forms an acute angle with the longitudinal axis of the first component.

FIG. 13 is perspective view of the second component approaching the first component in a direction that forms an acute angle with the longitudinal axis of the first component with the longitudinal axes of the first and second components forming an acute angle with respect to each other.

### DETAILED DESCRIPTION OF THE DRAWINGS AND THE PRESENTLY PREFERRED EMBODIMENTS

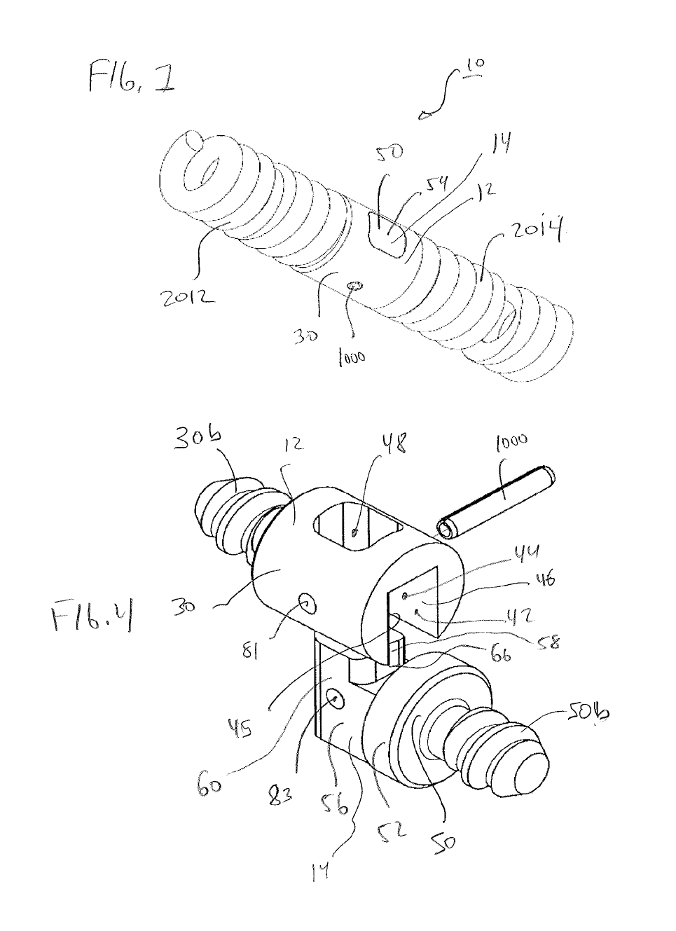

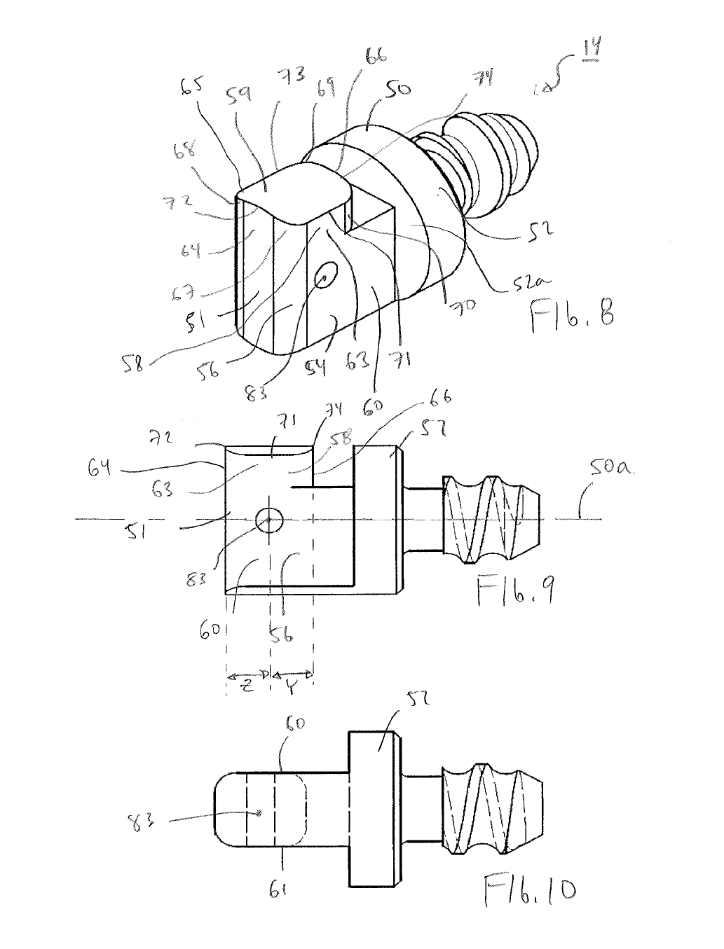

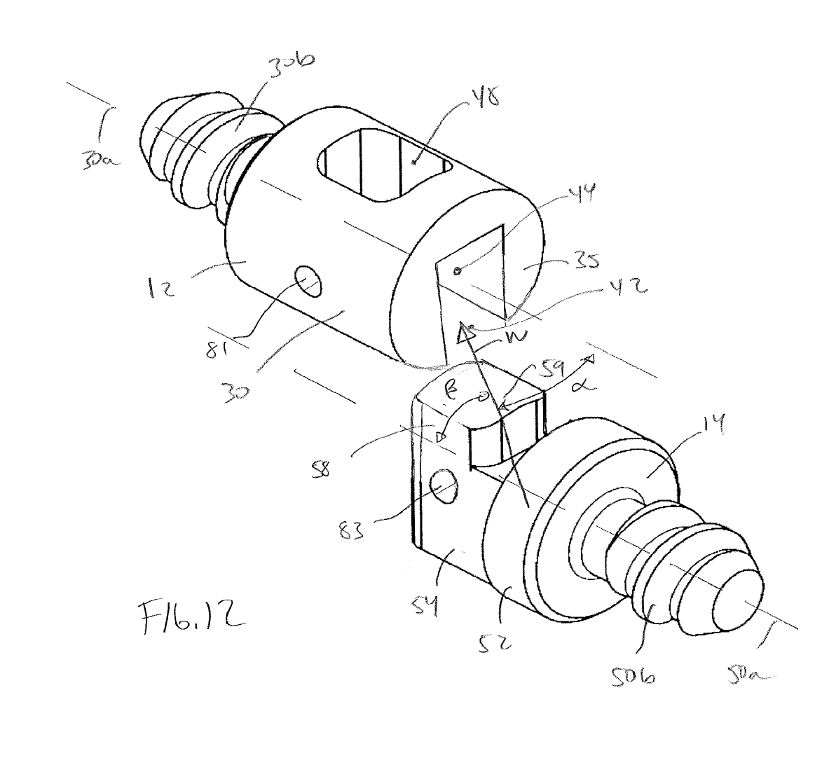

Turning now to FIGS. 1-13, a coupler 10 for connecting two cables, hoses, or other elongate members, in series is provided. The coupler 10 includes opposing but connectable first and second components 12, 14, each of which are fixed to ends of respective first and second cables 2012, 2014. The first and second cables 2012 and 2014 may be any type of elongate cable that may in use be desired to be connected to other similar cables in series to extend the working length of the cables. In some embodiments, such as the embodiment depicted in FIG. 1, the first and second cables 2012, 2014 may be drain cleaning cables that are configured to have one end of the series of the cables fixed to a rotatable component of a drain cleaning machine, and an opposite end extending free from the drain cleaning machine. The cables are configured to rotate about their longitudinal axis as a drum (or other component) of the drain cleaning machine rotates during operation, and the extended end of the cable is configured to receive a tool, such as a cutting tool, that rotates with the cable and mechanically removes clogs or other blockages within a pipe to be cleaned. In other embodiments, the first and second cables 2012, 2014 may be other types of cables, such as a torque transmission cable.

The first and second components 12, 14 are configured to be removably connectable together such that torque present in a first cable 2012 is transferred to the second cable 2014 when the first and second components 12, 14 are mated together.

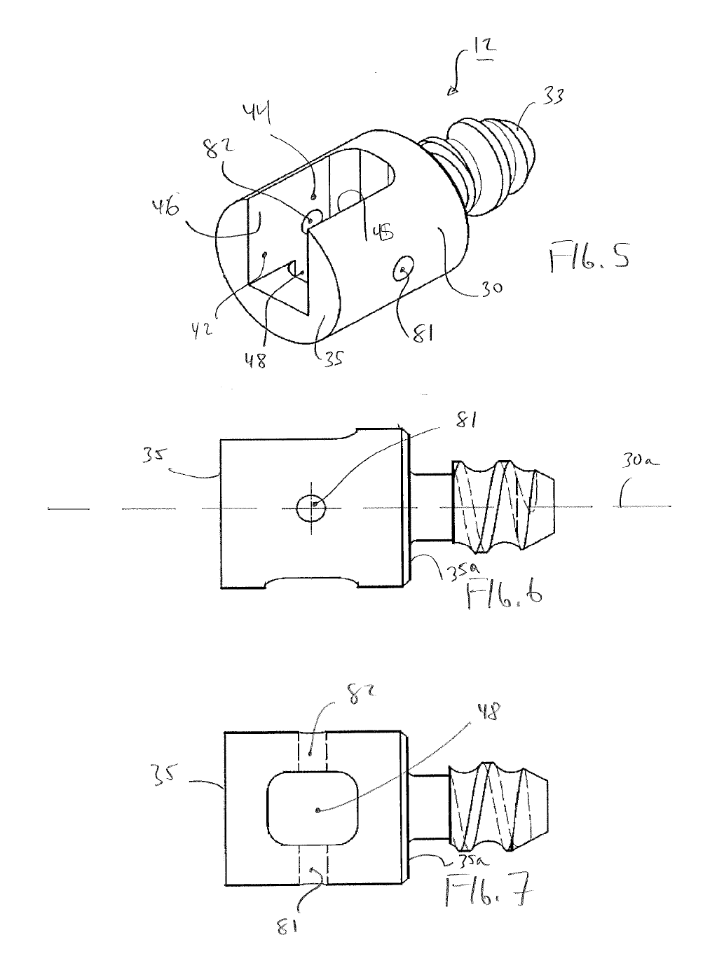

As best shown in FIGS. 4-7, the first component 12 includes a body 30 that extends from the first cable 2012 (when connected thereto) and a connecting portion 30b. The connecting portion 30b is configured to be fixedly connected to an end of a first cable 2012. In some embodiments, the connecting portion 30b may be extended into an aperture on the end of the first cable 2012, and may be fixed thereto, such as with a thread pattern on the connecting portion 30b (as shown in FIGS. 4-7) that engages the helical wire wound along an outer jacket of the first cable 2012. In other embodiments, one or more pins or other types of fasteners may fix the connecting portion 30b to the end of the first cable 2012, or other mechanical structures for connecting two rotatable components, and/or with adhesive, a welded connection, or the like may be used.

The body 30 is positioned to extend linearly from the first cable 2012, such that a longitudinal axis 30a of the first component 12 is coaxial with the longitudinal axis of the cable 2012 extending from the end of the cable 2012. The rigid connection between the first component 12 and the end of the first cable 2012 allows for torque in the first cable 2012 to be transferred to the first component 12, or alternatively in the opposite direction, i.e. from the first component 12 to the first cable 2012. The connection between the first cable 2012 and the first component 12 may be rigid such that there is no relative rotation between the end of the first cable 2012 and the first component 12 (even though the first cable 2012 may be configured to allow temporary relative rotational motion of the first cable 2012 along its length).

The body 30 of the first component 12 may be cylindrical, preferably with a diameter that is either equal to or less than a diameter of the first cable 2012. The body 30 extends from a first face 35 to a second face 35a from which the connecting portion 30b extends. The first face 35 may be perpendicular, or substantially perpendicular (e.g. about 90 degrees, such as between about 85 degrees and 95 degrees, inclusive of all angles therein) to the longitudinal axis 30a of the body 30. The first face 35 may be planar and through which extends an opening 42 defined in the first face 35. The opening 42 provides communication into a receiving volume 44 that extends blindly into the body 30. The receiving volume 44 is defined by opposite first and second planar side walls 45, 46 that extend blindly through the body from the opening 42, with the planar side walls 45, 46 forming respective edges on the face 35 at the opening 42 and forming edges with the arcuate side surface of the body 30.

The receiving volume 44 is configured to slidably receive a finger 54 of the second component 14 (discussed below) therein, with the length of the finger 54 being the same as, or just slightly less than, the length of the receiving volume in parallel to the longitudinal axis 30a. The receiving volume 44 additionally extends to an aperture 48 in the arcuate (in some embodiments circular) side surface of the body 30. The aperture 48 is configured to receive a portion of a finger 54 of the second component 14 (discussed in detail below) therewithin when the first component 12 is engaged with the second component 14 (in some embodiments when the respective longitudinal axes 30a, 50a of the first and second components 12, 14 are collinear). In some embodiments, the aperture 48 is formed in the same shape and size (normally just slightly larger than) the second portion 58 of the finger 54 (discussed below). In other embodiments, the aperture 48 may be a corresponding shape to the second portion 58 to minimize slippage or relative movement between the two when the second portion 58 extends into the aperture 48.

The body 30 additionally includes first and second holes 81 and 82 that extend along the same axis, with the first hole 81 extending through the first side wall 45 to the outer surface of the body 30 and the second hole 82 extending through the second side wall 46 to the outer surface of the body 30. The first and second holes 81, 82 are sized and aligned to receive a fastener 1000 (FIG. 4) therethrough, which retains the first and second components 12, 14 coupled together, as discussed below.

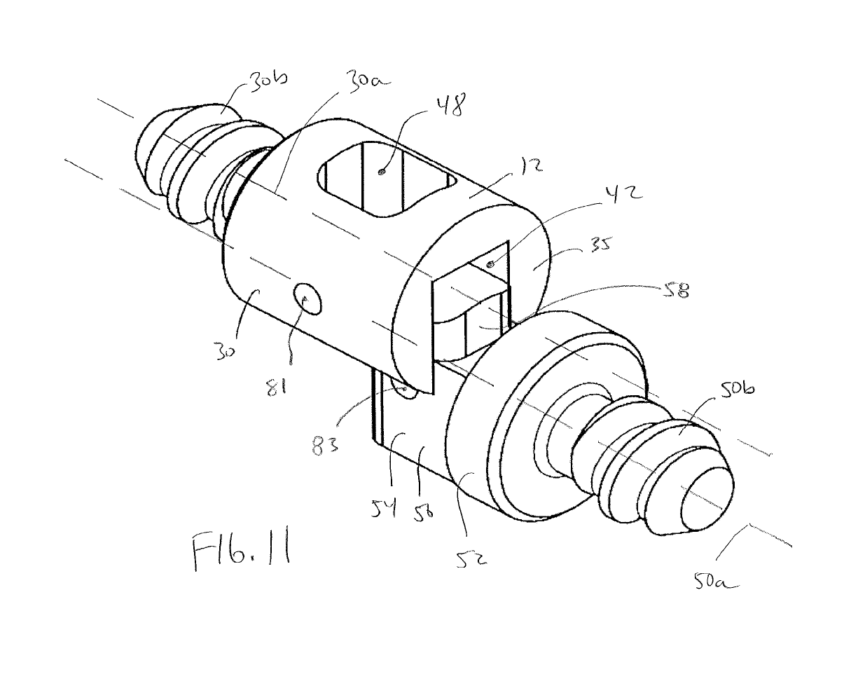

As best shown in FIGS. 8-10, the second component 14 includes a body 50 and a connecting portion 50b, which is configured to be connected to an end of a second cable 2014. In some embodiments, the connecting portion 50b is similar to connecting portion 30b, discussed above. The connecting portion 50b may be extended into an aperture on the end of the second cable 2014, and may be fixed thereto, such as with a thread pattern on the connecting portion 30b (as shown in FIGS. 4 and 8-10) that engages the helical wire wound along an outer jacket of the second cable 2014. In other embodiments, one or more pins or other types of fasteners may fix the connecting portion 530b to the end of the second cable 2014, or other mechanical structures for connecting two rotatable components, and/or with adhesive, a welded connection, or the like may be used.

The body 50 of the second component 50 includes a flange 52 and a finger 54, which extends from the flange 52 in parallel to and along the longitudinal axis 50a of the second component, and in an opposite direction than the connecting portion 50b extends from the flange 52. In some embodiments, the second component 14 is formed from a single monolithic component, such as a cast or a machined component. In other embodiments, the second component 14 may be multiple portions that are rigidly fixed together. The flange 52 may be a cylindrical component and in some embodiments the flange 52 includes the same diameter, or a smaller diameter, as the diameter of the body 30 of the first component 12. The flange 52 includes a face 52a that is configured to engage (or be very close to) the first face 35 of the first component 12 when the first component 12 engages the second component 14.

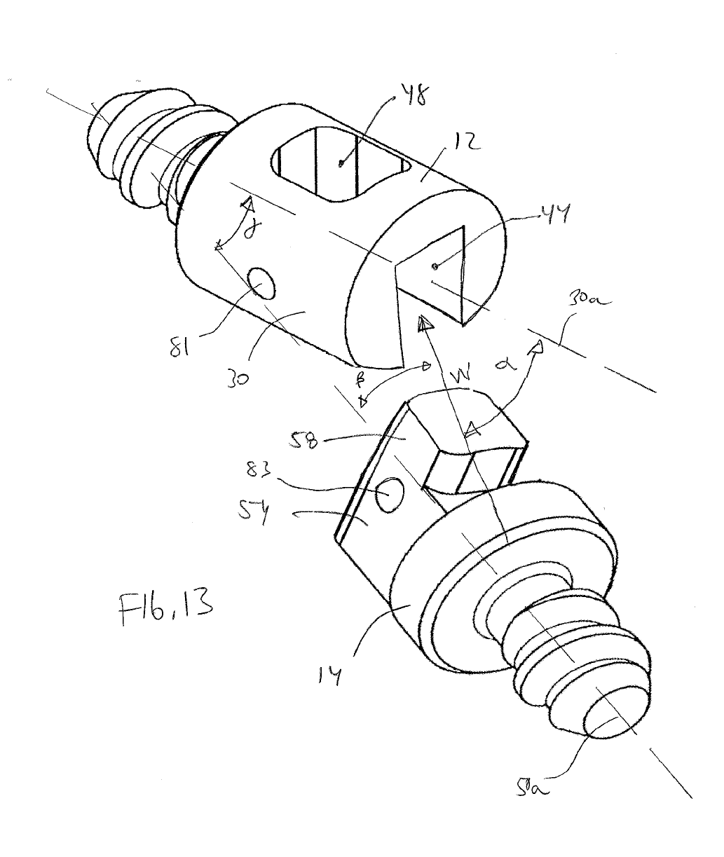

The finger 54 extends from the flange 52 and includes a first portion 56 that extends along the longitudinal axis 50a of the second component 14 and a second portion 58 that extends from an end of the finger 56 in a direction perpendicular, or substantially perpendicular (as defined above) to the longitudinal axis 50a. The first and second portions 56, 58 of the finger 54 are partially defined by parallel side walls 60, 61, which are continuous along both the first and second portions 56, 58. The first and second side walls 60, 61 may be parallel and may establish a width of the finger 54 that is just slightly smaller than a width of the receiving volume 44 of the first component 12 between the first and second side walls 45, 46 that partially define the receiving volume 44. The finger 54 is configured to slidably extend within the receiving volume 44. In some embodiments, the second component 14 is configured to approach the first component 12 in a direction parallel to both longitudinal axes 30a, 50a of the first and second components 12, 14, and with the respective longitudinal axes 30a, 50a of the first and second components 12, 14, parallel to but vertically offset from each other, with a portion of the second portion 58 of the finger 54 passing through the opening 42 on the first face 35 of the first component 12 and into the receiving volume 44. As discussed below, the second component 14 may also approach the first component such that the finger 54 enters into the receiving volume 44 in a direction substantially perpendicular (FIG. 4) to the longitudinal axis 30a of the first component, and the second component 14 may also approach the first component 12 such that the finger enters into the receiving volume 44 in a direction W (FIGS. 12, 13) that forms an acute angle α with respect to the first longitudinal axis 30a.

The second portion 58 of the finger 54 is best shown in FIGS. 8-10. The second portion 58 is partially bounded by two opposite side walls 63, 65 that are continuous and form a portion of the parallel side walls 60, 61 of the finger 54. The second portion 58 of the finger 54 is also bounded by front and rear walls 64, 66. The front and rear walls 64, 66 may each be perpendicular to the opposite side walls 63, 65. The front wall 64 may define the front face 51 of the finger 54, which also defines a portion of the front face of the second component 14. In some embodiments, one or more of the neighboring side walls 64, 65 and front and rear walls 64, 66 are connected with arcuate surface (67, 68, 69, 70; FIG. 8), while in other embodiments, neighboring side walls 63, 65 and front and rear walls 64, 66 may be connected with straight edges (that directly connect the respective walls), chamfered edges, or other geometrical structures known in the art.

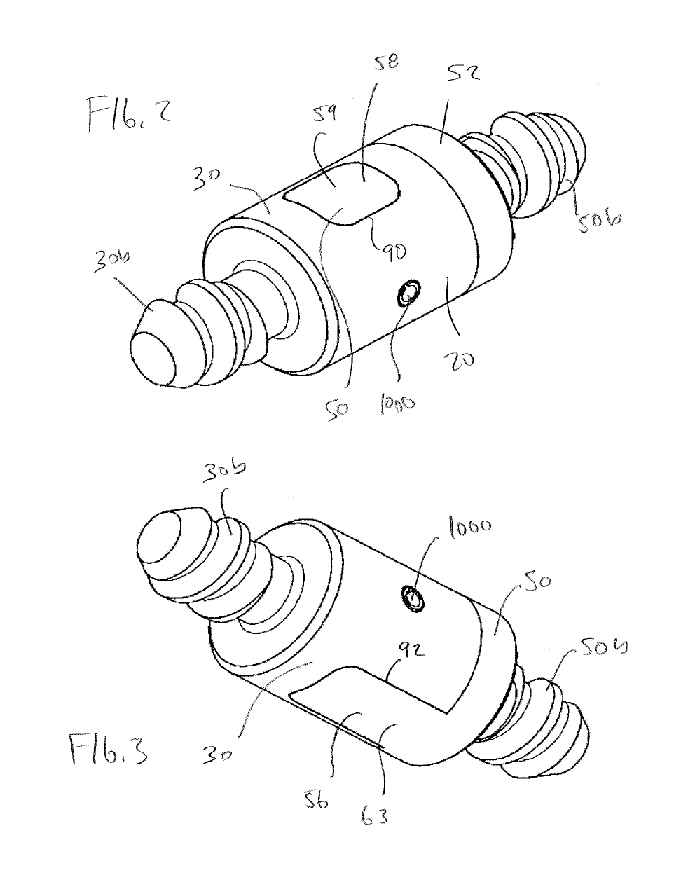

The second portion 58 of the finger 54 includes a top surface 59, which is visible through the aperture 48 through the body 30 of the first component 12 when the first and second components 12, 14 are engaged. In some embodiments, the top surface 59 is arcuate, such as with a radius of curvature that is the same as the radius of curvature of the side surface of the body 30 of the first component 12. In some embodiments, the second portion 58 of the finger 54 and the top surface 59 are sized and shaped such that when the first and second components 12, 14 are engaged together, the top surface 59 of the second portion 58 the side surface of the body 30 of the first component 12 in combination form a cylindrical profile (with the same diameter between the first and second components 12, 14) proximate to the second portion 58 and the aperture 48 (with the exception of an edge 90 formed therebetween (FIG. 2)). In other embodiments, the top surface 59 may reside within a portion of the aperture 48, and below the side surface of the body 30 when the first and second components 12, 14 are engaged. In some embodiments the edges 72, 74 between the top surface 59 and the front and rear walls 64, 66 are arcuate (which may match the curvature of the side surface of the body 30 of the first component 14), and the edges 71, 73 between the top surface 59 and the side walls 60, 61 are straight.

In some embodiments, the finger 54 may further include a curved bottom surface 63 that extends along the length of the finger 54, or for a portion of the length of the finger 54. The curved bottom surface 63 may include the same curvature as the side surface of the body 30 of the first component 12, such that when the first and second components 12, 14 are engaged, the side surface of the body 30 in combination with the curved bottom surface 64 may combine the form a cylindrical profile with the same diameter between the first and second components 12, 14 (with the exception of the edges formed between the side surface of the body 30 and the curved bottom surface 63, as shown in FIG. 3).

The finger 54 may include a hole 83 that is configured to receive a fastener (such as fastener 1000, FIG. 4) therethrough, which additionally extends through the first and second side holes 81, 82 in the side walls 45, 46 defining the receiving volume 44, i.e. the first and second holes 81, 82 of the first component 12 are co-axially aligned with the third hole 83, when the first component 12 is engaged with the second component 14, i.e. when the top surface 59 of the finger 58 extends through the aperture 48 in the first component 12. The fastener 1000 fixes the first and second components 12, 14 together when extending through the first, third, and second holes 81, 83, 82, which maintains the connection engaged and the first and second cables 2012, 2014 connected together in series when the cables are pulled in tension and when the cables are rotated along their length.

In some embodiments, the hole 83 may be positioned along a centerline of the depth of the second portion 58 of the finger 54 (when measured from the front to the rear of the second portion 58). Specifically, as depicted on FIG. 9, the distance Z between the front face 51 of the finger 54 to the center of the hole 83 may be the same as the distance Y between the center of the hole 83 and the rear wall 66 of the second portion 58. In other embodiments, the center of the hole 83 may be relatively closer to the front face 51 than the rear wall (e.g. Z>Y), while in other embodiments the center of the hole 83 may be relatively closer to the rear wall 66 (e.g. Y>Z). One of ordinary skill in the art will appreciate with a thorough review of this specification that the relative position of the hole 83 within the finger 54 may be a function of strength of the finger 54, or the first component 12 (due to the effect on the position of the first and second holes 81, 82). In other embodiments, the hole 83 may be otherwise positioned upon the finger 54 to facilitate securement with the first component 12 with the fastener 1000.

In some embodiments, the first and second components 12, 14 may be made from the same material, such as aluminum or steel. One or both of the first and second components 12, 14 may be a single monolithic component, or may be made from multiple components that are rigidly fixed together. In some embodiments, one or both of the first or second components 12, 14 may be made from a combination of materials to take advantage of desired weight or strength properties of certain materials, while minimizing the overall cost or weight of the overall connector 10.

In use, the connecting portion 30b of the first component 12 is fixed to an end of a first cable 2012 such that the first component 12 rotates simultaneously with rotation of the end of the first cable 2012. Similarly, the connecting portion 50b of the second component 14 is fixed to an end of a second cable 2014 such that the second component 14 rotates simultaneously with rotation of the second cable 14.

The second component 14 may then be engaged with or connected to the first component 12 by slidably inserting the finger 54 of the second component 14 into the receiving volume 44 of the first component 12, and advancing the finger 54 within the receiving volume 44 until a front face 51 of the finger 54 contacts or reaches extremely close proximity to the inner face of the receiving volume 44. The finger 54 may enter into the receiving volume 44 in a configuration such that a longitudinal axis 50a of the second component 14 is parallel to but offset vertically from a longitudinal axis 30a of the first component 12.

As best shown in FIG. 11, in some embodiments, at least a portion of the finger 54 (such as all or a portion of the second portion 58) may enter into the receiving volume 44 through the opening 42 on the front face 35 of the first component 12 and extend through the receiving volume 44 in a direction parallel to the longitudinal axis 30a of the first component 12 until the second portion 58 is able to extend through the aperture 48. The second portion 58 extends into the aperture 48 by translating the second component 14 with respect to the first component 12 in a direction perpendicular to the longitudinal axis 30a of the first component (and the longitudinal axis 50a of the second component 14). The first and second components 12 and 14 may also be configured such that the finger 54 of the second component 14 may extend into the receiving volume 44 in direction perpendicular to the longitudinal axis 30a of the first component 12, as shown in FIG. 3, with the second portion 58 engaging and sliding with the aperture 48 on the first component 12 along a continuous and straight movement.

Additionally, as shown in FIG. 12, at least a portion of the finger (such as the second portion 58) may initially approach and extend into the receiving volume 44 in a direction W to the longitudinal axis 30a of the first component 12 that forms an acute angle α to the longitudinal axis 30a of the first component 12. In some embodiments, the second component 145 may approach the receiving volume 44 in the direction W that forms a second acute angle β with the longitudinal axis 50a of the second component 14 that is the same as the first acute angle α (in situations where the first and second components are aligned with their longitudinal axes 30a, 50a in parallel). As shown in FIG. 13, the acute angle β may be different than the acute angle α, such as situations when the second component 14 is aligned with its longitudinal axis 50a forms an acute angle γ with respect to the longitudinal axis 30a of the first component and the second component 14 approaches the first component in the direction W. Similarly, the second component 14 may be aligned with respect to the first component 12 such that their longitudinal axes form the acute angle γ when the second component approaches the first component 12 in a direction parallel to the longitudinal axis 30a of the first component 12, and also when the second component 14 approaches the first component 12 in a direction perpendicular to the longitudinal axis 30a of the first component 12.

While the preferred embodiments of the disclosure have been described, it should be understood that the disclosure is not so limited and modifications may be made without departing from the invention. The scope of the invention is defined by the appended claims, and all devices that come within the meaning of the claims, either literally or by equivalence, are intended to be embraced therein.

1. A coupler for rotatably attaching two sections of an elongate cable, comprising:
a first component including a body that extends between a first end and a second end that is connectable to a first section, the body extending along a first longitudinal axis, the first component further comprising an opening disposed through a first face that defines the first end of the first component,
the first component further comprising a receiving volume that extends from the opening and blindly toward the second end of the first component, the receiving volume being partially bounded by opposite first and second parallel side walls, and a first aperture that extends from the receiving volume through an arcuate side wall of the first component; and
a second component including a body that extends between a first end and a second end that is connectable to an end of a second section, the body of the second component extending along a second longitudinal axis, the second component further comprising a flange and a finger that extends along the second longitudinal axis and includes a first portion that extends along the second longitudinal axis away from the flange, and a second portion that extends in a direction substantially perpendicular to the second longitudinal axis, wherein the first and second portions of the finger are both partially defined by opposite parallel side walls that are spaced apart substantially the same distance as a spacing between the first and second parallel side walls that partially bound the receiving volume,
wherein the finger is configured to be received within the receiving volume when the first and second components are connected together, with a top surface of the finger extending to the first aperture of the first component.

2. The coupler of claim 1, wherein the first face is planar and is disposed substantially perpendicularly to the first longitudinal axis

3. The coupler of claim 1, wherein second portion of the finger is configured to be able to slidably enter into the receiving volume in a direction parallel to the first longitudinal axis, and is configured to be able to slidably enter into the receiving volume in a direction perpendicular to the first longitudinal axis, and is configured to slidably enter into the receiving volume at an acute angle to the first longitudinal axis.

4. The coupler of claim 1, wherein the finger of the second coupler is configured to initially extend into the receiving volume with the respective first and second couplers aligned with their respective first and second longitudinal axes in parallel but linearly offset from each other.

5. The coupler of claim 1, wherein the finger of the second coupler is configured to initially extend into the receiving volume with the respective first and second couplers aligned with their respective first and second longitudinal axes forming an acute angle between each other.

6. The coupler of claim 4, wherein the second component is free to be translated radially with respect to the first component to allow the second portion of the finger to extend to the first aperture when a surface of the flange engages or is in very close proximity to the face of the first component.

7. The coupler of claim 4, wherein the first and second longitudinal axes of the respective first and second components are collinear when the second portion of the finger extends to the first aperture.

8. The coupler of claim 1, wherein an arcuate side wall of the body of the first component is cylindrical and the top surface of the finger is arcuate with the same curvature as the arcuate side wall of the body of the first component.

9. The coupler of claim 8, wherein the finger includes a curved bottom surface, wherein the curvature of the finger is the same radius as the curvature of the arcuate side wall of the body of the first component.

10. The coupler of claim 8, wherein the flange is cylindrical and is the same diameter as a diameter of the body of the first component.

11. The coupler of claim 1, wherein the second portion of the finger defines first, second, third, and fourth side walls, with each side wall perpendicular to its two neighboring side walls, and wherein the first and third side walls are continuous with the parallel side walls of the finger.

12. The coupler of claim 11, wherein neighboring first, second, third, and fourth side walls of the finger include an arcuate transition therebetween.

13. The coupler of claim 12, wherein the top surface of the second portion is partially defined by respective first, second, third, and fourth edges that extend between the top surface and the respective first, second, third, and fourth side walls, wherein the first and third edges are straight, and the second and fourth edges are arcuate.

14. The coupler of claim 1, wherein the first and second parallel side walls of the first component include respective first and second holes and the finger includes a third hole, wherein the first, third, and second holes are coaxially aligned when the top surface of the finger extends to the first aperture of the first component.

15. The coupler of claim 14, further comprising a fastener that is extendable through the first, third, and second holes.

16. The coupler of claim 14, wherein the first end of the body of the second component comprises a planar first face, and second hole is disposed through the finger such that a center of the second hole is equally spaced from the first face and a second face of the finger that is disposed upon the second portion of the finger and is parallel to and offset from the first face.

17. A method of rotatably connecting two sections of a cable, comprising:
providing a first component that includes a body that extends between a first end and a second end that is connectable to a first section, the body extending along a first longitudinal axis, the first component further comprising an opening disposed through a face that defines the first end of the first component, the first face being planar and disposed perpendicularly to the first longitudinal axis,
the first component further comprising a receiving volume that extends from the opening and blindly toward the second end of the first component, the receiving volume being partially bounded by opposite first and second parallel side walls, and a first aperture that extends through an arcuate side wall of the first component and extends into the receiving volume; and
providing a second component including a body that extends between a first end and a second end that is connectable to an end of a second section, the body of the second component extending along a second longitudinal axis, the second component further comprising a flange and a finger that extends along the second longitudinal axis and includes a first portion that extends along the second longitudinal axis away from the flange, and a second portion that extends in a direction substantially perpendicular to the second longitudinal axis, wherein the first and second portions of the finger are both partially defined by opposite parallel side walls that are spaced apart substantially the same distance as a spacing between the first and second parallel side walls that partially bound the receiving volume,
advancing the finger into the receiving volume and displacing the second component perpendicularly to the first longitudinal axis until a top surface of the finger extends to the first aperture of the first component.

18. The method of claim 17, wherein the first and second surfaces of the body of the first component each include respective first and second through holes, and the finger of the second component includes a third through hole, wherein the first, third, and second holes are coaxially aligned when the top surface of the finger extends to the first aperture of the first component, and further comprising the step of extending a fastener through each of the coaxially aligned first, third, and second holes.

19. The method of claim 17, wherein finger of the second component is configured to be able to extend into the receiving volume in a direction parallel to the first longitudinal axis, and in a direction perpendicular to the first longitudinal axis, and in a direction that forms an acute angle with respect the first longitudinal axis.

20. The method of claim 17, wherein the finger of the second component is configured to be able to extend into the receiving volume when the second component is aligned with respect to the first component such that the second longitudinal axis forms an acute angle with respect to the first longitudinal axis.
